(19) United States
(12) Patent Application Publication
(10) Pub. No.: US 2012/0139787 A1
(43) Pub. Date: Jun. 7, 2012

(54) Beam Steering And Manipulating Apparatus And Method

(76) Inventor: Chian Chiu Li, San Jose, CA (US)

(21) Appl. No.: 13/310,701

(22) Filed: Dec. 2, 2011

Related U.S. Application Data
(60) Provisional application No. 61/419,826, filed on Dec. 4, 2010.

(51) Int. Cl. H01Q 3/00

(52) U.S. Cl. 342/368

(57) ABSTRACT

An apparatus and method for electromagnetic beam steering and manipulating employ narrow beams in close proximity. The beam width and distance between neighboring beams are around or smaller than the wavelength. A strong beam is steered by a much weaker beam. A strong beam is also focused by a relatively small group of much weaker beams. The resulting device is compact and has better power efficiency.

### CROSS REFERENCE TO RELATED APPLICATION

This application claims the benefit under 35 U.S.C. Sec. 119 of provisional patent application Ser. No. 61/419,826, filed Dec. 4, 2010.

### FEDERALLY SPONSORED RESEARCH

Not applicable

### SEQUENCE LISTING OR PROGRAM

Not applicable

### BACKGROUND

1. Field of Invention

This invention relates to steering and manipulating electromagnetic beams, and particularly to steering and manipulating beams utilizing interferometric schemes.

2. Description of Prior Art

Electromagnetic beam steering has applications in free space optical communication, remote sensing, and compact projectors. Compared to conventional mechanical beam steering, nonmechanical beam steering has advantages of fast speed, compact structure, and potentially low cost. Current nonmechanical schemes include steering a collimated beam using phased array [P. F. McManamon, et al, “A Review of Phased Array Steering for Narrow-Band Electrooptical Systems”, Proceedings of the IEEE, 97, 6, 1078 (2009)], and steering or shaping a divergent beam using plasmonics and phase manipulation [F. Capasso, et al, “Methods and Apparatus for Improving Collimation of Radiation Beams”, US Patent Application #20100226134, (2010), and D. C. Adams, et al, “Plasmonic mid-IR beam steering”, Applied Physics Letter, 96, 201112, (2010)]. However, both nonmechanical methods involve a large number of beams having equal or moderate intensity, which usually means a complex structure and unnecessary power loss.

Therefore, there exists a need for beam steering scheme which requires less quantity of beams and lower beam intensity for the majority of beams involved in the process.

Beam as a term used here means any electromagnetic beam or electromagnetic wave which follows the Maxwell equations. Consequently, a beam may be of radiation in optical frequency range or radio frequency range, or in between, or beyond the two ranges.

### OBJECTS AND ADVANTAGES

Accordingly, several main objects and advantages of the present invention are:
a). to provide improved beam steering and manipulating device and method;
b). to provide such a device or method which utilizes less beams;
c). to provide such a device or method which utilizes beams of lower intensity; and
d). to provide such a device which is more compact and has smaller power loss.

Further objects and advantages will become apparent from a consideration of the drawings and ensuing description.

### SUMMARY

In accordance with the present invention, a beam steering and manipulating apparatus utilizes weak beam whose width is around or smaller than the wavelength to influence strong beam whose width is also around or smaller than the wavelength. Intensity of the weak beam can be much lower than that of the strong beam. The beams are spaced apart by a distance around or smaller than the wavelength. Unlike a traditional phased array method, where a large number of beams are required for steering effect, the strong beam can be steered by only one weak beam. And a strong beam can also be focused by a small number of weak beams. Due to less beams involved, the apparatus structure is simpler and more compact. On the other hand, use of weak beams reduces power loss and also makes it easier to accommodate propagation loss associated in some cases, for example, when plasmonics is employed to generate beams.

### DRAWING FIGURES

FIG. 1 shows a prior-art configuration of nonmechanical beam steering.

FIGS. 2-A to 2-C illustrate schematically an embodiment of beam steering and two examples of beam steering respectively.

FIGS. 3-A and 3-B show schematically another embodiment of beam steering in perspective and cross-sectional views.

FIGS. 4-A and 4-B depict schematically an embodiment of three-dimensional beam steering in perspective and cross-sectional views.

FIGS. 4-C and 4-D depict an example of three-dimensional beam steering.

FIGS. 5-A to 5-C shows schematically an embodiment of beam steering and manipulation.

FIGS. 6-A and 6-B illustrate schematically an embodiment of beam focusing.

FIG. 7 shows schematically another embodiment of beam manipulation.

FIG. 8 shows schematically an embodiment of beam manipulation in three-dimensional setting.

REFERENCE NUMERALS IN DRAWINGS

| | | | |
|---|---|---|---|
| 6 | Light source | 7 | Light source |
| 8 | Light source | 10 | Beam |
| 11 | Beam | 12 | Beam |
| 14 | Waveguide | 16 | Waveguide |
| 18 | Beam | 20 | Beam |
| 22 | Beam | 24 | Beam |
| 26 | Beam | 28 | Beam |
| 29 | Beam | 30 | Beam |
| 32 | Waveguide | 34 | Waveguide |
| 36 | Waveguide | 38 | Beam |
| 40 | Beam | 42 | Beam |
| 44 | Lens system | 46 | Lens system |

### DETAILED DESCRIPTION

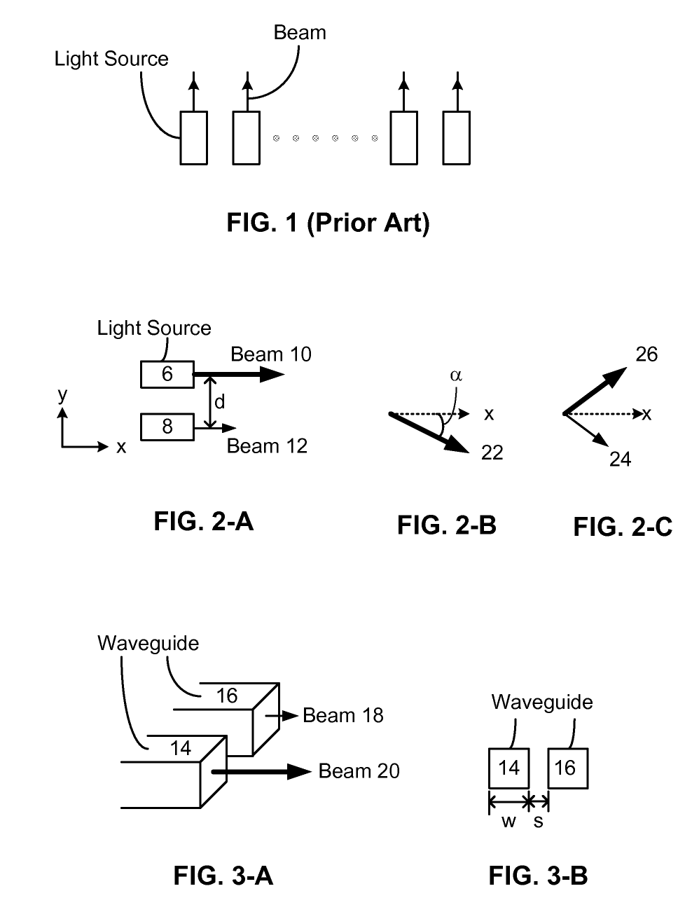

### FIG. 1—Prior-Art

FIG. 1 is a schematic view of a prior-art beam steering structure using phased array. The nonmechanical structure features a large number of radiation sources, which each produce an individual electromagnetic source beam. The source beams have the same or similar power level and are phase delayed respectively. Next, the source beams interfere among themselves and generate a resultant beam. The propagation direction of the resultant beam is determined by the phase of the individual source beams.

### FIGS. 2-A to 2-C and 3-A and 3-B Embodiments of Beam Steering Apparatus and Method

FIG. 2-A shows schematically a cross-sectional view of an embodiment of beam steering around one axis. Light sources 6 and 8 emit beams 10 and 12 along x-axis in x-y plane respectively. The beams are coherent. The width of the beams along y-axis is around or smaller than the wavelength of the beams. The spacing between the beams, represented by d in the figure along y-axis, is also around or smaller than the wavelength. In addition, the power of beam 10 is at least twice that of beam 12. Initially, only beam 10 is turned on, it propagates along x-axis. Then, beam 12 is powered on, and beams 10 and 12 mix and interfere with each other. Beam 12 can be used to change the propagation direction of beam 10. Two possible results of combining beams 10 and 12 are shown schematically in FIGS. 2-B and 2-C. FIG. 2-B shows an exemplary case when beam 12 is 90 degree out of phase relative to beam 10. A resultant beam 22 is single and transmitted at an angle alpha relative to x-axis. In FIG. 2-C, beams 10 and 12 are arranged 180 degree out of phase. Then two beams 24 and 26 are generated, where the intensity of beam 26 is larger than that of beam 24.

It is noted that beam 12 has at most half the power of beam 10, but the former can be used to change the propagation characteristics of the resultant beam by adjusting phase relationship between beams 10 and 12. In other words, a weak beam can be employed as a control beam to influence a strong signal beam, and the resultant beam can work as an output beam. The signal beam may be used to control propagation of the resultant beam, or it may carry signals in a communication system and the output beam may be used as a result of signal processing. The output beam may also be used as a probe beam in remote sensing systems.

As a control beam, low power level is desirable for reducing system power consumption. A relatively weak control beam also cuts power loss of the corresponding resultant beam, as the resultant beam comes from interference between signal and control beams. In addition, a relatively weak control beam contributes to maintaining beam quality of the resultant beam, especially when a signal beam is much stronger than a control beam. Back to FIG. 2-A, finite difference time domain simulations show that beam 12 can manipulate a resultant beam with ten percent or even one percent of the power of beam 10.

FIGS. 3-A and 3-B are schematic perspective and cross-sectional view showing an embodiment using waveguides 14 and 16. The waveguides are designed for emitting beams 18 and 20 and have the width w and separation s between them, where both w and s are around or smaller than the wavelength of the beams. Because of waveguide setup, beams 18 and 20 have width and spacing which are either around or smaller than the wavelength. Again, beam 20 can have at least twice the power of the other beam, beam 18. And a resultant beam can be manipulated by changing the phase of the weaker beam 18.

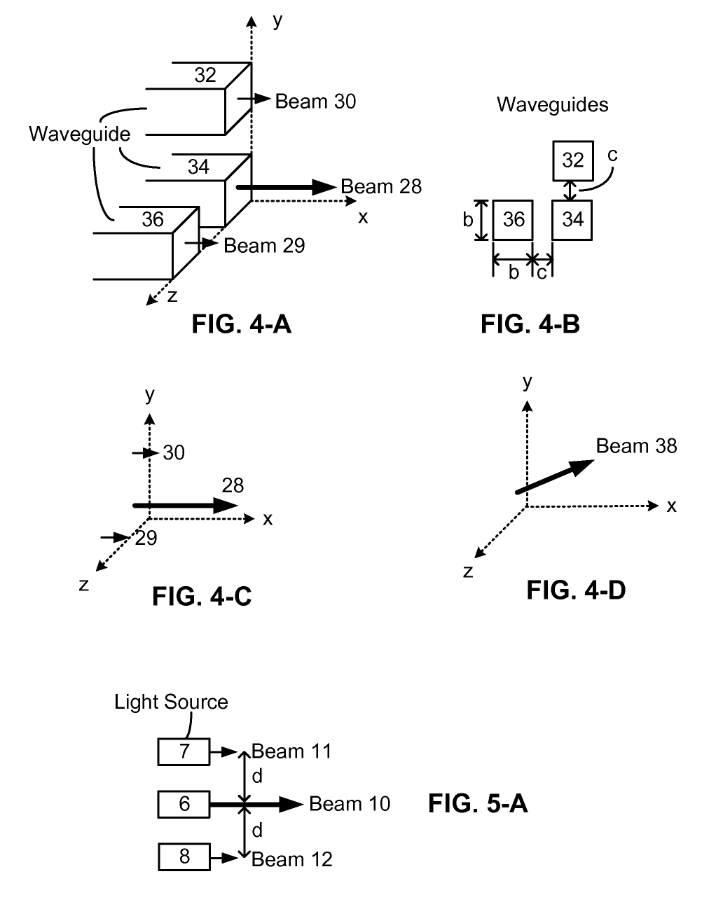

### FIGS. 4-A to 4-D Embodiment of Beam Steering Apparatus

Depicted in FIGS. 4-A to 4-D are drawings showing schematically an embodiment of two-axis beam steering or beam steering in three dimensions. In the figures, waveguides 32, 34, and 36 are positioned such that waveguides 32 and 34 are aligned along y-axis, while 34 and 36 are aligned along z-axis. The waveguides emit coherent beams 30, 28, and 29 respectively. The waveguides have a square-shaped cross section, whose width b and the spacing c between 32 and 34, or 36 and 34, are around or smaller than the wavelength of the beams. As a result, all three beams have the beam width that is around or smaller than the wavelength and their spacing along y or z axis is also around or smaller than the wavelength. Additionally, beam 28 serves as a signal beam, while beams 29 and 30 as control beam utilized for influencing propagation property of a resultant beam 38, as in FIG. 4-D. More specifically, beam 30 is used to control the angle of beam 38 around y axis, and beam 29 is used to control the angle around z axis. Thus beams 29 and 30 together can be used to steer beam 38 in three dimensions. As in the aforementioned two dimensional steering cases, the signal beam can have much higher power than the control beams. The power of beam 28 can be at least twice that of beams 29 and 30 combined, or ten times or even one hundred times of that of beam 29 or beam 30.

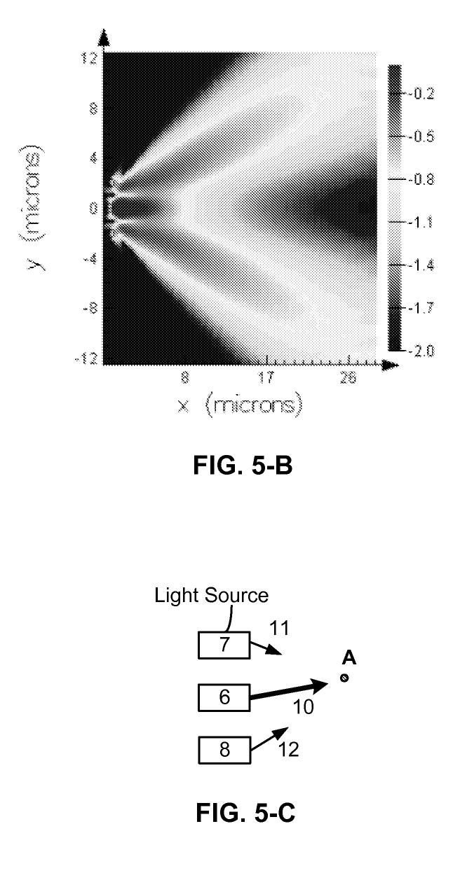

### FIGS. 5-A to 5-C, 6-A, and 6-B Embodiment of Beam Steering and Manipulation

FIG. 5-A shows schematically a modification of the embodiment of FIG. 2-A in a two-dimensional example. Here a source 7 is added which emits a beam 11 along x axis, for providing two control beams for one-axis beam manipulation. Similar to the configuration of FIG. 2-A, beam 10 is the signal beam and beams 11 and 12 are the control beams. And the beam width and separation d between the beams are around or smaller than the wavelength. When beams 11 and 12 are 180 degree out of phase with beam 10, two resultant beams are generated, which are transmitted forward forming a plus and minus angle relative to the x-axis in the x-y plane. Again, beams 11 and 12, as control beams, can have much lower power level than that of beam 10.

FIG. 5-B shows two-dimensional simulation results using finite difference time domain method. Configuration of the simulation is similar to that of FIG. 5-A. There are one signal and two control beams, where the former is in between the latter beams. Beams are created by passing plane waves through narrow slits. The signal and control beams are arranged 180 degree out of phase. Wavelength is of 1.55 microns, beam width 0.5 micron, spacing between two beams 1.5 microns, and intensity of the signal beam is ten times that of each control beam. The figure depicts calculated field intensity distribution of Ey in log scale, where the weak control beams make a resultant beam split into two beams, as compared to a single resultant beam when the beams are in phase (not shown in the figure).

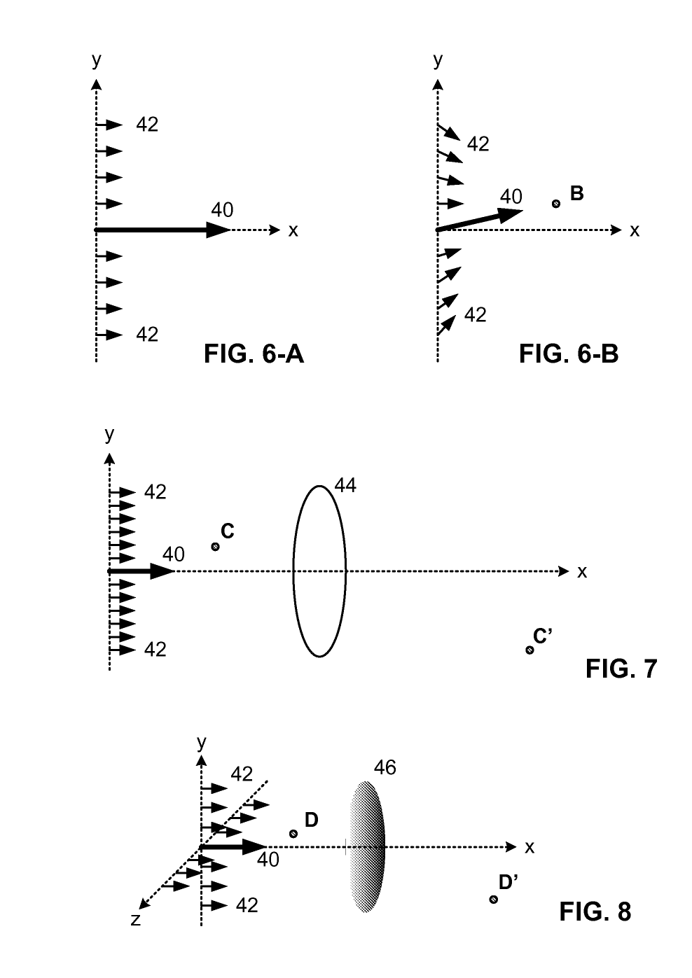

Furthermore, beams 10, 11, and 12 can be combined to form a converging beam; or in other words, beam 10 can be focused by beams 11 and 12, when three beams have a matching phase at a point, that is, the focal point. As illustrated in FIG. 5-C, when the phase of each beam is arranged such that they are in phase on a point A, the beams are focused on point A. In a conventional configuration, large quantities of beams which have similar intensity are employed to produce a focused beam. In comparison, only three beams are involved here for focusing in an extreme case. In FIG. 5-C, beam 10 can have much higher power than the other beams, similar to the beam steering examples discussed. It is noted that the focusing quality will degrade when the focus distance is much larger than the distance between control beams 11 and 12. For a larger focus length, more beams are used, as shown schematically in FIGS. 6-A and 6-B, where a beam 40 is of signal beam and beams 42 are of control beams. All beams have the beam width around or smaller than the wavelength and the spacing between neighboring beams is also around or smaller than the wavelength. And beam 40's power can be higher than the total power of beams 42. In FIG. 6-B, the beams are focused on a point B, indicating all beams are arranged in phase at point B. For beam manipulation in three dimensions, we can have two groups of control beams, which will be explained next.

### FIGS. 7 and 8 Embodiment of Beam Manipulation

FIG. 7 shows schematically an embodiment of beam manipulation utilizing a lens system 44. Like the example of FIG. 6-A, there are a strong beam 40 and multiple relatively weak beams 42, and the beam width and beam spacing is around or smaller than the wavelength. Adjust the phase of beams 42 respectively such that all the beams are in phase at a point C. Consequently, all beams mix and interfere with each other to form a convergent resultant beam and are focused on point C on one side of lens system 44. Next, the convergent beam becomes a divergent beam and is processed by lens system 44. Lens system 44 then turns the divergent beam into a convergent and focuses it again on a point C′ on the other side of lens system 44. Since adjusting the phase of beams 42 changes the position of point C, which in turn changes the position of C′, beam 42 can be used to dispose point C′ in a two dimensional space. Therefore, embodiment of FIG. 7 can be used for two dimensional steering, pointing, projection, communication, and sensing applications.

In FIG. 7 signal and control beams are positioned in one dimension and beam manipulation is carried out in two dimensions. For three-dimensional beam manipulation, another group of control beams in the third dimension is added as shown graphically in FIG. 8. This figure shows an embodiment where control beams are arranged along two directions, y and z axis. The total power of the control beams 42 can be smaller than the signal beam 40, and the control beams affect the propagation characteristics of the resultant beam. The resultant beam, as in FIG. 8, can be focused on a point D three-dimensionally. And point D in turn can be projected by a lens system 46 for creating an image point D′. The manipulation scheme finds use in similar applications to that discussed in above two-dimensional cases.

### CONCLUSION, RAMIFICATIONS, AND SCOPE

Thus it can be seen that apparatus and methods are introduced to steer or manipulate a strong beam using one weak beam or a small number of weak beams.

The described embodiments have the following features and advantages:
(1). Weak beam or beams are employed to steer or manipulate a strong beam;
(2). A smaller number of weak beams are employed to steer or manipulate a strong beam;
(3). A simple and compact structure; and
(4). Increased power efficiency.

Although the description above contains many specificities, these should not be construed as limiting the scope of the invention but as merely providing illustrations of some of the presently preferred embodiments. Numerous modifications will be obvious to those skilled in the art.

### Ramifications

Besides providing a beam using waveguide, a beam can also be arranged by a small opening, a small or nano sized source.

The lens system can be a conventional bulk-optics lens system, or micro-optics lens system, or a beam manipulating system utilizing phase modulation or plasmonics.

Lastly, more or less beams can be used compared to the examples described in the figures. Thus the quantity of beams in aforementioned cases is exemplary and can be changed to other small numbers.

Therefore the scope of the invention should be determined by the appended claims and their legal equivalents, rather than by the examples given.

1. An apparatus of electromagnetic waves comprising:
1) a source system of electromagnetic waves of a predetermined wavelength, said source system arranged for producing a first electromagnetic beam and one or no more than ten second electromagnetic beams respectively;
2) said source system arranged such that said first beam has the beam width around or smaller than said wavelength along a first predetermined direction and said first beam and one said second beam are spaced apart by a distance around or smaller than said wavelength along said first direction;
3) said source system arranged such that the power of said first beam is at least twice the power of each of said one or no more than ten second beams;
4) said apparatus arranged such that said first beam and said one or no more than ten second beams mix and interfere with each other for producing at least a third beam, wherein the propagation characteristics of said third beam is influenced by said one or no more than ten second beams.

2. The apparatus according to claim 1 wherein the power of said first beam is larger than the total power of said one or no more than ten second beams.

3. The apparatus according to claim 1 wherein the beam width of said one or no more than ten second beams is arranged around or smaller than said wavelength.

4. The apparatus according to claim 1 wherein said source system is arranged to produce at least one fourth electromagnetic beam, said first beam and said fourth beam being spaced apart by a distance around or smaller than said wavelength along a predetermined second direction.

5. The apparatus according to claim 1, further including tuning means for tuning the phase of said first beam or said one or no more than ten second beams.

6. An apparatus of electromagnetic waves comprising:
1) a source system of electromagnetic waves of a predetermined wavelength, said source system arranged for producing a first electromagnetic beam and a plurality of second electromagnetic beams respectively;
2) said source system arranged such that said first and second beams each have the beam width around or smaller than said wavelength along a predetermined first direction and one of said first and second beams is spaced apart from another of said first and second beams by a distance around or smaller than said wavelength along said first direction;
3) said source system arranged such that the power of said first beam is at least larger than the total power of said second beams;
4) said apparatus arranged such that said first and second beams mix and interfere with each other for producing at least one third electromagnetic beam, wherein the propagation characteristics of said third beam is influenced by said second beams.

7. The apparatus according to claim 6, further including a fourth electromagnetic beam generated by said source system, wherein said fourth beam is arranged such that it is spaced apart from said first beam by a distance around or smaller than said wavelength along a predetermined second direction.

8. The apparatus according to claim 6, further including tuning means for tuning the phase of said first beam or said second beams.

9. The apparatus according to claim 6 wherein said first and second beams are arranged such that said third beam converges at a spot.

10. The apparatus according to claim 6, further including beam means for converting said third beam into a fourth electromagnetic beam.

11. An apparatus of electromagnetic waves comprising:
1) a source system of electromagnetic waves of a predetermined wavelength, said source system arranged for producing a first electromagnetic beam, at least one second electromagnetic beam, and at least one third electromagnetic beam respectively;
2) said source system arranged such that said first beam has the beam width around or smaller than said wavelength along a predetermined first and a predetermined second direction respectively, said first and said second beam are spaced apart by a distance around or smaller than said wavelength along said first direction, and said first and said third beam are spaced apart by a distance around or smaller than said wavelength along said second direction, wherein said first and second direction arranged to be different;
3) said source system arranged such that the power of said first beam is larger than the power of each of said second beam or said third beam;
4) said apparatus arranged such that said first, second, and third beams mix and interfere with each other for producing at least one fourth electromagnetic beam, wherein the propagation characteristics of said fourth beam is influenced by said second beam and said third beam.

12. The apparatus according to claim 11 wherein the beam width of said second beam and said third beam is arranged around or smaller than said wavelength along said first and second direction respectively.

13. The apparatus according to claim 11, further including tuning means for tuning the phase of said first beam, said second beam, or said third beam.

14. The apparatus according to claim 11, further including beam means for converting said fourth beam into a fifth electromagnetic beam.
